(19) United States
(12) Patent Application Publication
(10) Pub. No.: US 2013/0043026 A1
(43) Pub. Date: Feb. 21, 2013

(54) Compositions And Methods For Servicing Subterranean Wells

(71) Applicants: Salim Taoutaou, Kuala Lumpur (MY); Shameed Ashraf, Kuala Lumpur (MY); Khalid Abdel Hadi, Doha (QA)

(72) Inventors: Salim Taoutaou, Kuala Lumpur (MY); Shameed Ashraf, Kuala Lumpur (MY); Khalid Abdel Hadi, Doha (QA)

(73) Assignee: SCHLUMBERGER TECHNOLOGY CORPORATION, Sugar Land, TX (US)

(21) Appl. No.: 13/209,918

(22) Filed: Aug. 15, 2011

(51) Int. Cl. E21B 33/13; C04B 7/02; C04B 9/02; C04B 28/10; C04B 7/32; C04B 14/36; C04B 18/06

(52) U.S. Cl. 166/293; 106/814; 106/717; 106/710; 106/796; 106/692; 106/685

(57) ABSTRACT

Resilient graphitic carbon may be an effective lost-circulation control agent for well-cementing compositions. During primary or remedial cementing, the carbon particles may hinder or prevent the egress of the well-cementing composition from the wellbore into subterranean formations via formation fissures or cracks. The carbon particles may also be added to spacer fluids, chemical washes or both.

### BACKGROUND

The statements in this section merely provide background information related to the present disclosure and may not constitute prior art.

This disclosure relates to methods for controlling lost circulation in subterranean wells, in particular, fluid compositions and methods for operations during which the fluid compositions are pumped into a wellbore, enter voids in the subterranean-well formation through which wellbore fluids escape, and form a seal that limits further egress of wellbore fluid from the wellbore into the formation.

During construction of a subterranean well, drilling and cementing operations are performed that involve circulating fluids in and out of the well. The fluids exert hydrostatic and pumping pressure against the subterranean rock formations, and may induce a condition known as lost circulation. Lost circulation is the total or partial loss of drilling fluids or cement slurries into highly permeable zones, cavernous formations and fractures or voids. Such openings may be naturally occurring or induced by pressure exerted during pumping operations. Lost circulation should not be confused with fluid loss, which is a filtration process wherein the liquid phase of a drilling fluid or cement slurry escapes into the formation, leaving the solid components behind.

Lost circulation can be an expensive and time consuming problem. During drilling, this loss may vary from a gradual lowering of the mud level in the pits to a complete loss of returns. Lost circulation may also pose a safety hazard, leading to well-control problems and environmental incidents. During cementing, lost circulation may severely compromise the quality of the cement job, reducing annular coverage, leaving casing exposed to corrosive downhole fluids, and failing to provide adequate zonal isolation. Lost circulation may also be a problem encountered during well-completion and workover operations, potentially causing formation damage, lost reserves and even loss of the well.

Lost-circulation solutions may be classified into three principal categories: bridging agents, surface-mixed systems and downhole-mixed systems. Bridging agents, also known as lost-circulation materials (LCMs), are solids of various sizes and shapes (e.g., granular, lamellar, fibrous and mixtures thereof). They are generally chosen according to the size of the voids or cracks in the subterranean formation (if known) and, as fluid escapes into the formation, congregate and form a barrier that minimizes or stops further fluid flow. Surface-mixed systems are generally fluids composed of a hydraulic cement slurry or a polymer solution that enters voids in the subterranean formation, sets or thickens, and forms a seal that minimizes or stops further fluid flow. Downhole-mixed systems generally consist of two or more fluids that, upon making contact in the wellbore or the lost-circulation zone, form a viscous plug or a precipitate that seals the zone.

A thorough overview of LCMs, surface-mixed systems and downhole-mixed systems, including guidelines for choosing the appropriate solution for a given situation, is presented in the following reference: Daccord G, Craster B, Ladva H, Jones TGJ and Manescu G: “Cement-Formation Interactions,” in Nelson E B and Guillot D (eds.): Well Cementing—2^{nd} Edition, Houston: Schlumberger (2006): 202-219.

Many materials and compositions exist to prevent or combat lost circulation but, despite the valuable contributions of the prior art, it would be advantageous to have compositions and methods that do not negatively affect cement performance.

### SUMMARY

In the present disclosure, means are provided to seal voids and cracks in subterranean-formation rock during well cementing operations, thereby minimizing or stopping fluid flow from the wellbore into the formation rock.

In an aspect, embodiments relate to well cementing compositions.

In a further aspect, embodiments relate to methods for controlling lost circulation while cementing a subterranean well.

In yet a further aspect, embodiments relate to methods for cementing a subterranean well.

### BRIEF DESCRIPTION OF THE DRAWINGS

FIG. 1 shows the design of a test cell to measure the plugging ability of a lost-circulation material.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments should not be construed as a limitation to the scope and applicability of the disclosed embodiments. While the compositions of the present disclosure are described herein as comprising certain materials, it should be understood that the composition could optionally comprise two or more chemically different materials. In addition, the composition can also comprise some components other than the ones already cited.

The Applicants have surprisingly discovered that cement slurries comprising resilient-graphitic-carbon particles have the ability to limit fluid flow in passageways of a size consistent with many lost-circulation zones in subterranean wells. This discovery has led to the development of methods by which such fluids may be applied to solving lost-circulation problems during well cementing.

Graphitic carbon particles are generally considered to be “resilient” if, after applying a compaction pressure of 70 MPa (10,000 psi), the particles expand and recover at least 20 percent of their original volume. For the present use, resiliency of at least 80 percent is preferred. Resiliency exceeding 100 percent is even more preferred.

Embodiments relate to well-cementing compositions. The compositions comprise an inorganic cement, water and resilient graphitic carbon. Inorganic cements may include (but would not be limited to) Portland cement, cement kiln dust, a lime/silica blend, a lime/pozzolan blend, calcium aluminate cement, chemically bonded phosphate ceramics, geopolymers, or Sorel cement, or combinations thereof. The particle size of the resilient graphitic carbon is preferably about 97% smaller than 2400 micrometers and about 96% larger than 200 micrometers. The resilient graphitic carbon is preferably present at a concentration between about 60 kg/m³ and about 285 kg/m³, and more preferably between about 86 kg/m³ and about 260 kg/m³. Those skilled in the art will understand that, depending on the treatment conditions, additional materials may be added to the composition. Such materials include (but would not be limited to) accelerators, retarders, extenders, weighting agents, dispersants, fluid-loss additives, expanding additives, fibers and elastomers.

Embodiments relate to methods for controlling lost circulation while cementing a well. A well-cementing composition is provided that comprises an inorganic cement, water and resilient graphitic carbon. The composition is placed in the well such that the composition directly contacts one or more subterranean formations. Hydraulic pressure is then applied to the composition such that a pressure differential exists between the composition and one or more subterranean formations.

The compositions comprise an inorganic cement, water and resilient graphitic carbon. Inorganic cements may include (but would not be limited to) Portland cement, cement kiln dust, a lime/silica blend, a lime/pozzolan blend, calcium aluminate cement, chemically bonded phosphate ceramics, geopolymers, or Sorel cement, or combinations thereof. The particle size of the resilient graphitic carbon is preferably about 97% smaller than 2400 micrometers and about 96% larger than 200 micrometers. The resilient graphitic carbon is preferably present at a concentration between about 60 kg/m³ and about 285 kg/m³, and more preferably between about 86 kg/m³ and about 260 kg/m³. Those skilled in the art will understand that, depending on the treatment conditions, additional materials may be added to the composition. Such materials include (but would not be limited to) accelerators, retarders, extenders, weighting agents, dispersants, fluid-loss additives, expanding additives, fibers and elastomers.

Placement of the composition may be during primary cementing, remedial cementing or both. During primary cementing, the composition may be placed conventionally by pumping down a tubular body and then up into the annulus between the tubular body and the subterranean formation. Or, the “reverse cementing” method may be employed whereby the composition is pumped from the surface down into the annulus. Remedial cementing may be performed by several techniques including (but not limited to) a running squeeze, a hesitation squeeze, plug cementing and dump-bailer cementing. In all cases, the cementing composition directly contacts one or more subterranean formations.

Hydraulic pressure may be applied by hydrostatic pressure, pumping pressure, or both. The hydraulic pressure may provide sufficient force to cause the well cementing composition to begin exiting the wellbore and enter fissures or cracks in the subterranean formation. The resilient-graphitic-carbon particles in the composition may then congregate around the fissures or cracks, forming a barrier that prevents further movement of the well cementing composition out of the wellbore and into the subterranean formation.

The methods may also involve the use of spacer fluids, chemical washes or both. It is envisioned that resilient graphic carbon may also be incorporated in these fluids during the performance of the methods.

Embodiments relate to methods for cementing a subterranean well. A well-cementing composition is provided that comprises an inorganic cement, water and resilient graphitic carbon. The composition is then placed in the well.

The compositions comprise an inorganic cement, water and resilient graphitic carbon. Inorganic cements may include (but would not be limited to) Portland cement, cement kiln dust, a lime/silica blend, a lime/pozzolan blend, calcium aluminate cement, chemically bonded phosphate ceramics, geopolymers, or Sorel cement, or combinations thereof. The particle size of the resilient graphitic carbon is preferably about 97% smaller than 2400 micrometers and about 96% larger than 200 micrometers. The resilient graphitic carbon is preferably present at a concentration between about 60 kg/m³ and about 285 kg/m³, and more preferably between about 86 kg/m³ and about 260 kg/m³. Those skilled in the art will understand that, depending on the treatment conditions, additional materials may be added to the composition. Such materials include (but would not be limited to) accelerators, retarders, extenders, weighting agents, dispersants, fluid-loss additives, expanding additives, fibers and elastomers.

Placement of the composition may be during primary cementing, remedial cementing or both. During primary cementing, the composition may be placed conventionally by pumping down a tubular body and then up into the annulus between the tubular body and the subterranean formation. Or, the “reverse cementing” method may be employed whereby the composition is pumped from the surface down into the annulus. Remedial cementing may be performed by several techniques including (but not limited to) a running squeeze, a hesitation squeeze, plug cementing and dump-bailer cementing. In all cases, the cementing composition directly contacts one or more subterranean formations.

The methods may also involve the use of spacer fluids, scavenger fluids chemical washes or both. It is envisioned that resilient graphic carbon may also be incorporated in these fluids during the performance of the methods.

### EXAMPLES

The following examples serve to further illustrate the invention.

All tests were performed with a 1500-kg/m³ (12.5-lbm/gal) Portland cement base slurry containing bentonite as an extender. The slurry was prepared in accordance with standard API/ISO test methods published in ISO Document 10426-2, entitled “Recommended Practice for Testing Well Cements.” The slurry properties are shown in Table 1.

TABLE 1
Base slurry properties.

| Parameter | Value | |
|---|---|---|
| Thickening Time (hr:min) | 7:00 | |
| Fluid-Loss (mL) | 98 | |
| Rheological Properties | PV (cP) | Ty (1 bm/100 ft²) |
| @ 25° C. | 34 | 5 |
| @ 76° C. | 56 | 44 |

| | |
|---|---|
| Compressive Strength (MPa) | |
| @ 12 hr | 366 |
| @ 24 hr | 563 |
| @ 48 hr | 707 |

### Example 1

A series of plugging tests was performed to assess the performance of resilient graphitic carbon as a lost-circulation control agent. The carbon was RGC 01S, available from Superior Graphite Company, Chicago, Ill. The specific gravity of this material is 1.56. The particle-size distribution was measured with a series of sieves, and the result is presented in Table 2.

TABLE 2
Particle-size distribution of RGC 01S.

| Aperture Size | | | Cumulative |
|---|---|---|---|
| (mm) | US Mesh No. | Weight Percent | Weight Percent |
| 4.00 | 5 | 1.17 | 1.17 |
| 2.36 | 8 | 2.11 | 3.28 |
| 1.18 | 16 | 17.9 | 21.2 |
| 0.71 | 25 | 24.0 | 45.2 |
| 0.43 | 40 | 29.1 | 74.3 |
| 0.21 | 70 | 22.0 | 96.3 |
| — | Pan | 3.7 | 100 |

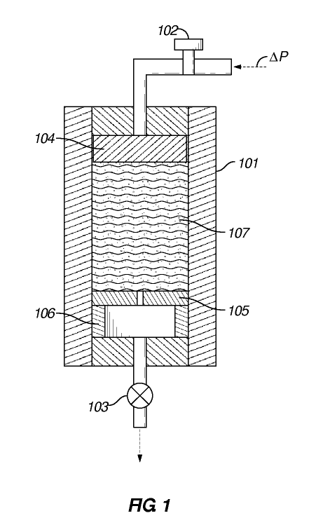

The RGC 01S was added to the base slurry described above, at a concentration of 86 kg/m³ (30 lbm/bbl). The slurry was then tested with a pressure-filtration cell, illustrated in FIG. 1.

The test cell 101 is fabricated from stainless steel, and has an internal volume of 600 mL. There is a valve 102 at the cell inlet and a valve 103 at the cell outlet. At the top of the cell is a piston 104. At the bottom of the cell there is a slot assembly 105. Assemblies were used with the following slot widths: 3.0 mm, 5.0 mm and 7.2 mm. These widths may correspond to typical cracks or fissures in a subterranean formation. A holder 106 secures the slot assembly. The test slurry 107 is placed between the piston and the slot assembly. During a test, nitrogen pressure is applied at the cell inlet, and the valve 102 is opened, thereby exerting pressure on the piston 104. Valve 103 is then opened, causing the piston 104 to begin moving downward, and forcing fluid 107 to begin flowing through the slot and out of the bottom of the cell 101. The filtration process continues until the slot becomes plugged. The volume of fluid that passed through the slot is recorded. The testing was performed at pressured up to 3.5 MPa (500 psi), and the results are presented in Table 3. A result indicating the cell was “plugged” means that a negligible volume of filtrate was collected.

TABLE 3
Plugging efficiency test results.
Accumulated Filtrate Volume (mL)

| Slot Size | 3.0 mm | 5.0 mm | 7.2 mm |
|---|---|---|---|
| 0.00 MPa (0 psi) | 50 | 70 | 110 |
| 0.34 MPa (50 psi) | 70 | 80 | 130 |
| 0.69 MPa (100 psi) | Plugged | Plugged | 560 |
| 1.38 MPa (200 psi) | Plugged | Plugged | Plugged |
| 20.7 MPa (300 psi) | Plugged | Plugged | Plugged |
| 2.76 MPa (400 psi) | Plugged | Plugged | Plugged |
| 3.45 MPa (500 psi) | Plugged | Plugged | Plugged |

### Example 2

The effects of resilient graphitic carbon on the mechanical properties of set cement were measured. The tests involved the same base slurry and carbon described in Example 1. The measured parameters were: static Young's modulus, unconfined compressive strength, Poisson's ratio and tensile strength. The test methods are described in the following publication. Dargaud B and Boukhelifa L: “Laboratory Testing, Evaluation and Analysis of Well Cements,” in Nelson EB and Guillot D (eds.): Well Cementing—2^{nd} Edition, Houston: Schlumberger (2006): 627-677.

Various concentrations of carbon were added to the base cement, ranging from 86 kg/m³ (30 lbm/bbl) to 257 kg/m³ (90 lbm/bbl). The results are shown in Table 4.

TABLE 4
Effects of resilient graphitic carbon on the
mechanical properties of set cement.

| | Base | 86 | 143 | 200 | 257 |
|---|---|---|---|---|---|
| Parameter | Slurry | kg/m³ | kg/m³ | kg/m³ | kg/m³ |
| Unconfined | 6.55 | 6.21 | 5.96 | 6.31 | 6.14 |
| Compressive | | | | | |
| Strength (MPa) | | | | | |
| Tensile | 1.63 | 1.60 | 1.59 | 1.43 | 1.35 |
| Strength (MPa) | | | | | |
| Young's | 1800 | 1450 | 1640 | 1730 | 1770 |
| Modulus (MPa) | | | | | |
| Poisson's Ratio | 0.17 | 0.14 | 0.14 | 0.12 | 0.12 |

1. A well-cementing composition, comprising an inorganic cement, water and resilient graphitic carbon.

2. The composition of claim 1, wherein the resilient graphitic carbon particle size is about 97% smaller than 2400 micrometers and about 96% larger than 200 micrometers.

3. The composition of claim 1, wherein the resilient graphitic carbon concentration is between about 60 kg/m³ and about 285 kg/m³.

4. The composition of claim 1, wherein the resiliency of the graphitic carbon exceeds 80 percent.

5. The composition of claim 1, wherein the cement comprises Portland cement, cement kiln dust, a lime/silica blend, a lime/pozzolan blend, calcium aluminate cement, chemically bonded phosphate ceramics, geopolymers, or Sorel cement, or combinations thereof.

6. A method for controlling lost circulation while cementing a subterranean well, comprising:
(i) providing a well-cementing composition that comprises an inorganic cement, water and resilient graphitic carbon;
(ii) placing the composition in the well such that the composition directly contacts one or more subterranean formations; and
(iii) applying hydraulic pressure to the composition such that a pressure differential exists between the composition and one or more subterranean formations.

7. The method of claim 6, wherein the composition is placed in the well during a primary cementing operation.

8. The method of claim 6, wherein the composition is placed in the well during a remedial cementing operation.

9. The method of claim 6, further comprising placing a spacer fluid containing resilient graphitic carbon, or a chemical wash containing resilient graphitic carbon, or both in the well.

10. The method of claim 6, wherein the resilient graphitic carbon particle size is about 97% smaller than 2400 micrometers and about 96% larger than 200 micrometers.

11. The method of claim 6, wherein the resilient graphitic carbon concentration is between about 60 kg/m³ and about 285 kg/m³.

12. The method of claim 6, wherein the resiliency of the graphitic carbon exceeds 80 percent.

13. The method of claim 6, wherein the cement comprises Portland cement, cement kiln dust, a lime/silica blend, a lime/pozzolan blend, calcium aluminate cement, chemically bonded phosphate ceramics, geopolymers, or Sorel cement, or combinations thereof.

14. A method for cementing a subterranean well, comprising:
(i) providing a well-cementing composition that comprises an inorganic cement, water and resilient graphitic carbon; and
(ii) placing the composition in the well.

15. The method of claim 14, wherein the composition is placed in the well during a primary cementing operation.

16. The method of claim 14, wherein the composition is placed in the well during a remedial cementing operation.

17. The method of claim 14, further comprising placing a spacer fluid containing resilient graphitic carbon, or a chemical wash containing resilient graphitic carbon, or both in the well.

18. The method of claim 14, wherein the carbon particle size is about 97% smaller than 2400 micrometers and about 96% larger than 200 micrometers.

19. The method of claim 14, wherein the resilient graphitic carbon concentration is between about 60 kg/m³ and about 285 kg/m³.

20. The method of claim 14, wherein the resiliency of the graphitic carbon exceeds 80 percent.
